(19) United States
(12) Patent Application Publication
(10) Pub. No.: US 2026/0231285 A1
(43) Pub. Date: Aug. 6, 2026

(54) RADIO NETWORK NODE AND METHOD FOR AVOIDING OVERHEATING

(71) Applicant: TELEFONAKTIEBOLAGETLM ERICSSON (PUBL), Stockholm (SE)

(72) Inventors: Ezequias M. S. de Santana Jr., Fortaleza, Ceará (BR); Igor Moáco Guerreiro, Fortaleza, Ceará (BR); Arne Simonsson, Gammelstad (SE); Anders Landström, Boden (SE)

(21) Appl. No.: 19/150,317

(22) PCT Filed: Feb. 8, 2023
(86) PCT No.: PCT/SE2023/050102

§ 371 Date: Jul. 23, 2025

(51) Int. Cl. H04W 76/28; H04W 56/00

(52) U.S. Cl. CPC H04W 76/28; H04W 56/0015

(57) ABSTRACT

Embodiments herein relate to, for example, a method performed by a radio network node for handling communication in a wireless communication network. The radio network node determines whether or not a first condition related to a first parameter associated with a slot counter of the radio network node, and/or a second condition related to a second parameter associated with a transmission of one or more synchronization signals is fulfilled. The radio network node, based on whether the first and/or the second condition is fulfilled or not, performs an operation action related to transmission and/or reception of one or more signals.

### TECHNICAL FIELD

Embodiments herein relate to a radio network node and method performed therein regarding wireless communication. Furthermore, a computer program product and a computer-readable storage medium are also provided herein. Especially, embodiments herein relate to handling or enabling communication, such as managing operation modes of communication, in a wireless communication network.

### BACKGROUND

In a typical wireless communication network, user equipments (UE), also known as wireless communication devices, mobile stations, stations (STA) and/or wireless devices, communicate via a Radio Access Network (RAN) to one or more core networks (CN). The RAN covers a geographical area which is divided into service areas or cell areas, with each service area or cell area being served by a radio network node such as an access node e.g. a Wi-Fi access point or a radio base station (RBS), which in some radio access technologies (RAT) may also be called, for example, a NodeB, an evolved NodeB (eNodeB) and a gNodeB (gNB). The service area or cell area is a geographical area where radio coverage is provided by a radio network node. The radio network node operates on radio frequencies to communicate over an air interface with the UEs within range of the access node. The radio network node communicates over a downlink (DL) to the UE, and the UE communicates over an uplink (UL) to the access node.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipments. In a forum known as the Third Generation Partnership Project (3GPP), telecommunications suppliers propose and agree upon standards for present and future generation networks and UTRAN specifically, and investigate enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more CNs.

Specifications for the Evolved Packet System (EPS) have been completed within the 3^{rd} Generation Partnership Project (3GPP) and this work continues in the coming 3GPP releases, such as fifth generation (5G) and sixth generation (6G) networks. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the RAN of an EPS has an essentially non-hierarchical architecture comprising radio network nodes connected directly to one or more CNs.

With the emerging 5G technologies also known as new radio (NR), the use of very many transmit- and receive-antenna elements may utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

System operations in higher frequencies, e.g., such as in mmW and THz bands, is adopted as a key technology to enable extremely high data rates for 5G and beyond, such as 6G. Such frequency bands feature wider system bandwidth compared to those in lower frequency ranges, such as below 6 GHz adopted in legacy systems.

In this context, there are two key aspects. First, to properly operate in such higher frequencies, analog beamforming providing large beamforming gains is needed to compensate for severe propagation losses. That is because the propagation loss decays more rapidly with distance as the wavelength is made shorter. Such gains are obtained with directional, time-multiplexed beam-based transmissions. Second, the use of wider system bandwidths demands more computational resources. Critical computations such as analog-digital (AD) and/or digital-analog (DA) conversions and power amplifier linearization, e.g., digital pre-distortion, using higher sampling rates make the radio processing unit operate in a higher clock regime. Thus, it consumes much more power. Consequently, the amount of dissipated energy converted into heat might expose radio components to overheating conditions. Such conditions can limit the overall system performance.

From a coverage perspective, radio network nodes periodically transmit several reference signals (RS) to provide adequate coverage within their cell sectors. In 5G NR, this is carried out via beam management procedures with synchronization signal block (SSB) transmission from radio network nodes in mmW bands. The set of all SSBs is referred to as an SSB burst set and its transmission is basic for a minimum system operating condition.

Going up beyond NR bands, however, narrower analog beams are used to obtain even larger beamforming gains. That implies more time-multiplexed SSB transmissions to keep cell coverage. Then, current radio network nodes equipped with NR multiple input multiple output (MIMO) radios designed to operate in mmW bands may suffer from overheating in beyond-NR bands, e.g., those above 100 GHz, with system bandwidths in the order of GHz. Furthermore, the shorter wavelength also results in denser MIMO antenna grid increasing the challenge of cooling power amplifiers and other components.

Thermal and/or energy issues may be mitigated by introducing transmission/reception discontinuities, herein referred to as Discontinuous Reception (DRX) and/or Discontinuous Transmission (DTX). Basically, DTX and/or DRX configuration comprises DTX states to set the radio network node and/or the UE to active, inactive and sleep modes. Particularly, during inactive and sleep modes radio units can relief their thermal condition. DRX is commonly carried out at UEs to increase their power efficiency whenever there is no data to deliver to them. At radio network nodes, DTX is adopted to decrease the network energy consumption whenever there is no traffic/signaling to transmit to UEs.

### SUMMARY

As part of developing embodiments herein, one or more problems were first identified. Existing DTX and/or DRX approaches usually focus only on energy consumption. That is, the existing DTX and/or DRX approaches do not cope with the potential increase in power consumption for reference transmission in systems with operation in beyond-NR bands. This may not guarantee the basic operation of a system, which herein is referred to as the transmission of SSB burst sets. For instance, a radio network node can reach a critical thermal condition during data activity to/from UEs between two SSB burst sets. Since it must transmit the following SSB burst set, it can reach an overheating condition, being unable to transmit data and reference signals while its temperature cools down. This can create a coverage hole and may decrease performance of the wireless communication network.

An object of embodiments herein is, thus, to provide a mechanism that improves the performance of a wireless communication network.

According to an aspect, the object is achieved by providing a method performed by a radio network node for handling communication in a wireless communication network. The radio network node determines whether or not a first condition related to a first parameter associated with a slot counter of the radio network node, and/or a second condition related to a second parameter associated with a transmission of one or more synchronization signals is fulfilled. The radio network node further, based on whether the first and/or the second condition is fulfilled or not, performs an operation action related to transmission and/or reception of one or more signals.

According to still another aspect, the object is achieved by providing a radio network node for handling communication in a wireless communication network. The radio network node is configured to determine whether or not a first condition related to a first parameter associated with a slot counter of the radio network node, and/or a second condition related to a second parameter associated with a transmission of one or more synchronization signals is fulfilled. The radio network node is further configured to perform, based on whether the first and/or the second condition is fulfilled or not, an operation action related to transmission and/or reception of one or more signals.

It is furthermore provided herein a computer program product comprising instructions, which, when executed on at least one processor, cause the at least one processor to carry out any of the methods herein, as performed by the radio network node. It is additionally provided herein a computer-readable storage medium, having stored thereon a computer program product comprising instructions which, when executed on at least one processor, cause the at least one processor to carry out any of the methods herein, as performed by the radio network node.

Thus, embodiments herein disclose a system that uses an operational state configuration, such as, for example, a gNB-specific DTX configuration for reference transmission, wherein the operational state configuration comprises parameters such as a slot budget and a slot counter threshold. The radio network node may enter a sleep mode whenever either a slot counter and/or the slot budget goes beyond the slot counter threshold, and the radio network node may stay in sleep mode until the expected power dissipation to be consumed during, for example, a following SSB burst set transmission is guaranteed not make the radio network node reach an overheating condition after transmitting the SSB burst set.

Thus, embodiments herein are handling communication resulting in an improved performance of the wireless communication network since the radio network node avoids overheating in a resource efficient manner.

### BRIEF DESCRIPTION OF THE DRAWINGS

Embodiments will now be described in more detail in relation to the enclosed drawings, in which:

FIG. 1 is a schematic overview depicting a wireless communication network according to embodiments herein;

FIG. 2 is a combined signalling scheme and flowchart according to embodiments herein;

FIG. 3 is a flowchart depicting a method in a radio network node according to embodiments herein;

FIG. 4 is a flowchart depicting a method in a radio network node according to some embodiments herein;

FIG. 5 is a diagram depicting slot counter values vs operational state of a radio network node according to some embodiments herein;

FIG. 6 is a block diagram depicting a radio network node according to embodiments herein;

FIG. 7 schematically illustrates a telecommunication network connected via an intermediate network to a host computer;

FIG. 8 is a generalized block diagram of a host computer communicating via a base station with a user equipment over a partially wireless connection; and

FIGS. 9, 10, 11, and 12 are flowcharts illustrating methods implemented in a communication system including a host computer, a base station and a user equipment.

### DETAILED DESCRIPTION

Embodiments herein are described within the context of 3GPP NR radio technology. It is understood that the problems and solutions described herein are equally applicable to wireless access networks and UEs implementing other access technologies and standards. NR is used as an example technology where embodiments are suitable, and using NR in the description therefore is particularly useful for understanding the problem and solutions solving the problem. In particular, embodiments are applicable also to 6G, 3GPP LTE, or 3GPP LTE and NR integration, also denoted as non-standalone NR.

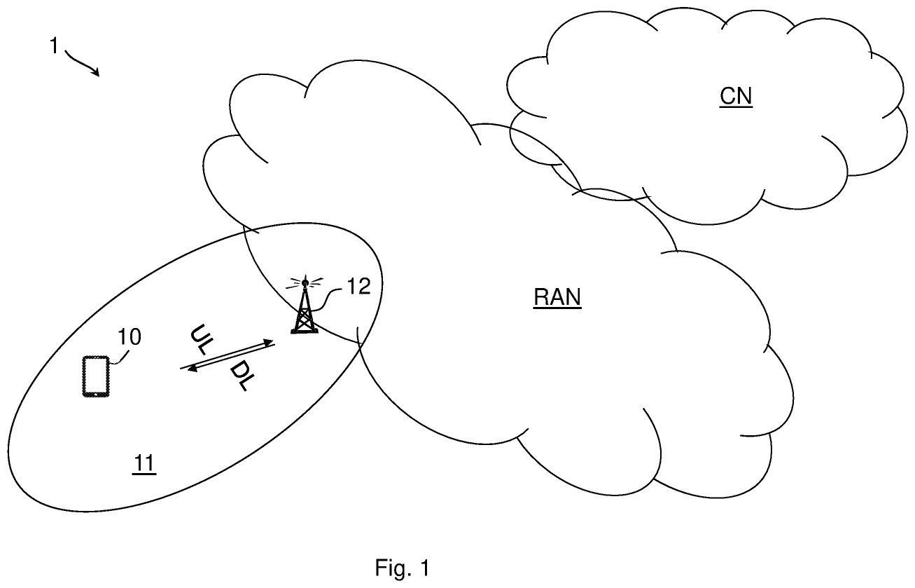

Embodiments herein relate to wireless communication networks in general. FIG. 1 is a schematic overview depicting a wireless communication network 1. The wireless communication network 1 comprises one or more RANs and one or more CNs. The wireless communication network 1 may use one or a number of different technologies, such as Wi-Fi, LTE, LTE-Advanced, 5G, WCDMA, Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

In the wireless communication network 1, wireless devices e.g. a UE 10, such as a mobile station, a non-access point (non-AP) STA, a STA, a user equipment and/or a wireless terminal, communicate via one or more Access Networks (AN), e.g. RAN, to one or more CN. It should be understood by the skilled in the art that “UE” is a non-limiting term which means any terminal, wireless communication terminal, user equipment, Machine Type Communication (MTC) device, internet of things (IoT) capable device, Device to Device (D2D) terminal, or node e.g. smart phone, laptop, mobile phone, sensor, relay, mobile tablets or even a small base station capable of communicating using radio communication with a network node within an area served by the network node.

The wireless communication network 1 comprises a radio network node 12 providing radio coverage over a geographical area, a first service area 11, of a radio access technology (RAT), such as NR, LTE, Wi-Fi, WiMAX or similar. The radio network node 12 may be a transmission and reception point e.g. a radio network node such as a Wireless Local Area Network (WLAN) access point or an Access Point Station (AP STA), an access node, an access controller, a base station, e.g. a radio base station such as a NodeB, an evolved Node B (eNB, eNode B), a gNodeB (gNB), a base transceiver station, a radio remote unit, an Access Point Base Station, a base station router, a transmission arrangement of a radio base station, a stand-alone access point or any other network unit or node capable of communicating with a UE within the area served by the radio network node 12 depending e.g. on the radio access technology and terminology used. The radio network node 12 may alternatively or additionally be a controller node or a packet processing node such as a radio controller node or similar. It should be noted that a service area may be denoted as cell, beam, beam group, or similar, to define an area of radio coverage.

The radio network node 12 may be referred to as a serving network node wherein the first service area may be referred to as a serving cell or primary cell, and the serving network node communicates with the UEs in form of DL transmissions to the UEs and UL transmissions from the UEs.

Embodiments herein relate to a method wherein the radio network node 12 determines whether or not a first condition related to a first parameter associated with a slot counter of the radio network node, and/or a second condition related to a second parameter associated with a transmission of one or more synchronization signals is fulfilled. The radio network node further, based on whether the first and/or the second condition is fulfilled or not, performs an operation action related to transmission and/or reception of one or more signals. The first condition may define that the first parameter, such as slot counter value, does not reach or exceed a first threshold. The second condition may define that the second parameter, such as number of slots to transmit an SSB, in addition to a current slot counter value does not reach or exceed a second threshold, which may be the same as the first threshold.

Thus, embodiments herein may be adapted to different network setups and conditions by dynamically adjust operational state configuration parameters, making an efficient use of the radio resources while avoiding the overheating of radio units at radio network nodes. Coverage is preserved by guarantee heating and power margin for important reference signals.

Note that, in a general scenario, the term “radio network node” can be substituted with “transmission point”. Distinction between the transmission points (TP) or transmission radio points (TRP) may typically be based on cell reference signals (CRS) or different synchronization signals transmitted. Several TPs may be logically connected to the same radio network node, but, if they are geographically separated or are pointing in different propagation directions, the TPs may be subject to the same mobility issues as different radio network nodes. In subsequent sections, the terms “radio network node”, TRP, and “TP” can be thought of as interchangeable.

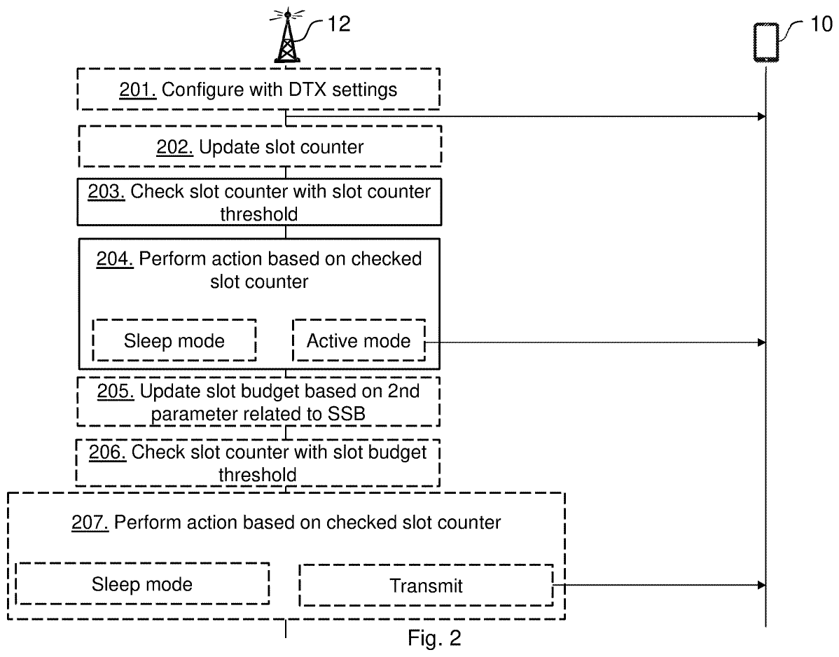

FIG. 2 is a combined flowchart and signalling scheme according to some embodiments herein. The actions may be performed in any suitable order.

Action 201. The radio network node 12 may be configured with a DTX setting or configuration.

Action 202. The radio network node 12 may update a slot counter with a value upon transmission of data in a slot.

Action 203. The radio network node 12 determines whether or not a first condition related to the first parameter associated with the slot counter of the radio network node 12 is fulfilled. The radio network node 12 may check the value of the slot counter with a slot counter threshold, being an example of the first threshold.

Action 204. The radio network node 12 may then upon reached or exceeded the slot counter threshold or not perform an operation action. For example, the radio network node 12 may upon reached threshold switch to an inactive or sleep mode of transmission of data. Otherwise, the radio network node 12 may proceed in active mode and transmit data.

Action 205. The radio network node 12 may then update a slot budget, which is based on the second parameter associated with a transmission of one or more synchronization signals. The second parameter may comprise a parameter indicating numbers of slots to transmit an SSB or any other reference signal or pilot signals. This second parameter may be configured, pre-set or estimated at the radio network node 12.

Action 206. The radio network node 12 determines whether or not the second condition related to the second parameter is fulfilled. For example, the radio network node 12 may check the current value of the slot counter together with the updated slot budget and compare it with a slot budget threshold that may be the same as the slot counter threshold.

Action 207. The radio network node 12 may then upon reached or exceeded the slot budget threshold or not perform an operation action. For example, the radio network node 12 may upon reached slot budget threshold switch to an inactive or sleep mode of transmission of data. Otherwise, the radio network node 12 may proceed in active mode and transmit data or synchronization signals.

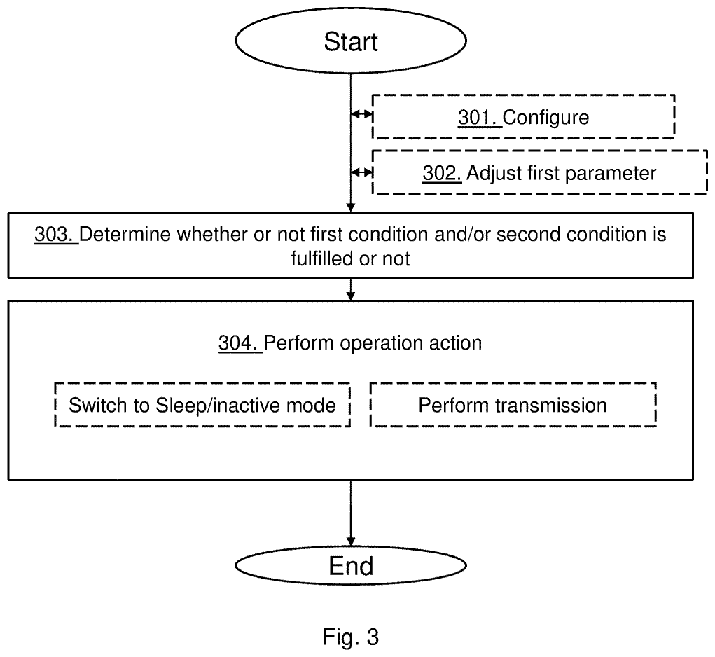

The method actions performed by the radio network node 12 for handling communication in the wireless communication network 1 according to embodiments herein will now be described with reference to a flowchart depicted in FIG. 3. The actions do not have to be taken in the order stated below, but may be taken in any suitable order. Actions performed in some embodiments are marked with dashed boxes.

Action 301. The radio network node 12 may configure the second parameter based on transmission of a block synchronization signals.

Action 302. The radio network node 12 may adjust the first parameter associated with the slot counter based on performing a transmission operation of the radio network node. The first parameter may be based on one or more readings of a transmission counter and/or a temperature sensor of the radio network node.

Action 303. The radio network node 12 determines whether or not the first condition related to the first parameter associated with a slot counter of the radio network node 12, and/or the second condition related to the second parameter associated with a transmission of one or more synchronization signals is fulfilled.

Action 304. The radio network node 12, based on whether the first and/or the second condition is fulfilled or not, performs an operation action related to transmission and/or reception of one or more signals. For example, the radio network node 12 may adapt a DTX and/or a DRX configuration based on whether the first and/or the second condition is fulfilled or not. The first condition may comprise a first threshold for the first parameter, which first threshold defines an upper limit of the first parameter. The first parameter may comprise a counter value or a degree value. The first condition may state that the slot counter should not reach the slot counter value. The second condition may comprise a second threshold related to the second parameter. The second threshold may be defined by the first parameter and the second parameter. The first parameter may comprise a slot counter value and the second parameter may comprise a value for transmitting an SSB. The second parameter may comprise a counter value or a degree value of transmitting an SSB. The second condition may state that the current slot counter value and the number of slots to transmit synchronization signals should not reach the slot counter threshold. The first and second threshold or thresholds may be combined with a temperature sensor. The margins can be adjusted to an actual temperature. For example, by adjusting threshold levels. Alternatively, an algorithm may operate in degree scale rather than slot-counting thresholds and slot budget in degrees and counting up in fraction of degrees at transmission.

The operation action may comprise switching an operation mode of the radio network node 12 to a sleep mode or an inactive mode in case the first condition and/or the second condition is not fulfilled, i.e., in case the first threshold and/or the second threshold is reached. The radio network node 12 may be kept in sleep mode or inactive mode based on a pre-set time interval, which pre-set time interval is related to whether it was the first condition or the second condition that was not fulfilled. The operation action may comprise transmitting a synchronization signal or a data transmission in case the first condition and/or the second condition is fulfilled, i.e., in case the first threshold and/or the second threshold is not reached.

Thus, it is herein disclosed a method performed by the radio network node 12 for handling communication in a wireless communication network, the method may comprise, based on one or more indications relative a set threshold associated with a maximum operation temperature of the radio network node 12, setting an operation state of the radio network node 12, wherein the one or more indications are related to number of transmissions and indicating an operation temperature of the radio network node 12. The one or more indications may comprise a first indication indicating a counter value of transmissions and/or a second indication indicating one or more transmission for transmitting a synchronization signal. The set operation state of the radio network node 12 may be based on both the first indication and the second indication. The one or more indications may be based on one or more readings of a transmission counter and/or a temperature sensor of the radio network node 12.

Alternatively, a method performed by the radio network node 12 for handling communication in a wireless communication network, may comprise determining whether one or more indications reach or exceed a set threshold associated with a maximum operation temperature of the radio network node 12, wherein the one or more indications are related to number of transmissions and indicating an operation temperature of the radio network node; and setting the radio network node 12 into an operation state based on the determination. The one or more indications may comprise a first indication indicating a counter value of transmissions and/or a second indication indicating one or more transmission for transmitting a synchronization signal. The set operation state of the radio network node 12 may be based on both the first indication and the second indication. The one or more indications may be based on one or more readings of a transmission counter and/or a temperature sensor of the radio network node 12.

Thus, a method performed by the radio network node 12 for handling communication in a wireless communication network, may comprise determining whether or not, a first indication of a slot counter of the radio network node 12 and/or a second indication of a parameter related to transmission of one or more synchronization signals reaches or exceeds a set threshold associated with a maximum operation temperature of the radio network node 12. The method further comprises performing an operation action based on whether the first indication and/or the second indication reaches or exceeds the set threshold or not. The radio network node 12 may estimate the second indication based on a parameter related to transmission of one or more synchronization signals. The first indication may be based on one or more readings of a transmission counter and/or a temperature sensor of the radio network node 12. The radio network node 12 may adjust the first indication based on a transmission operation of the radio network node. The operation action may comprise switching an operation mode of the radio network node 12 to a sleep mode in case the first indication and/or the second indication reaches or exceeds the state threshold. The operation action may comprise transmitting a synchronization signal or a data transmission in case the first indication and/or the second indication does not reach or exceed the state threshold. The first indication may comprise a counter value or a degree value. The second indication may comprise a counter value or a degree value of transmitting an SSB.

Hence, it is herein disclosed a method for reference transmission, the method may comprise one or more of the following actions:

One or more radio network nodes are configured to have a slot counter, a slot counter threshold and a slot budget as part of a communication configuration such as a DTX configuration;
a radio network node 12 may update its slot counter, incrementing it whenever a slot transmitted, or decrementing it otherwise;
the radio network node 12 may enter sleep mode whether its slot counter reaches the configured slot counter threshold, and may stay at sleep mode until a first configured back-off period is followed;
the radio network node 12 may update its slot budget according to i) a configured number of slots needed to transmit a following SSB burst set and ii) a number of remaining slots until the beginning of the following SSB burst set transmission;
the radio network node 12 may enter sleep mode whether its slot budget reaches the configured slot counter threshold, and may stay at sleep mode until a second configured back-off period is followed.

The slot budget may also be based on any other reference signals or pilot signals specific for a UE.

The thresholds may be combined with a temperature sensor. The margins can be adjusted to an actual temperature. For example, by adjusting levels of the first and/or second threshold. Alternatively, an algorithm may operate in degree scale rather than slot-counting thresholds and slot budget in degrees and counting up in fraction of degrees at transmission.

An update of the first and/or second threshold or the slot counter value may be refined by including slot utilization such as number of frequency resources or symbols in slot. Also, other power amplifier heating parameters may be accounted for such as transmission power level (or back-off) and/or a modulation type. For example, the more power/frequencies used the lower the first and/or second threshold is set, or the higher the counter value of the slot counter is increased.

Thus, it is herein disclosed a method that controls the transmission of slots by one or more radio network nodes to avoid the overheating of their radio units, the method comprising a slot counting procedure and the evaluation of slot counting conditions, such conditions may trigger an operational sleep mode at a radio network node whenever one of such conditions is violated.

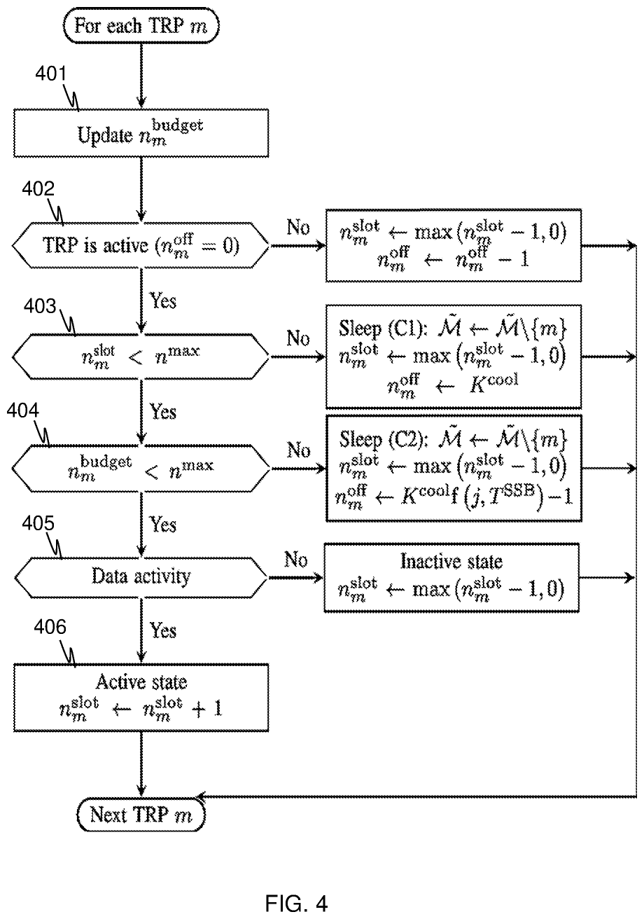

FIG. 4 shows a flowchart of a proposed DTX method, giving more details of an example of the method and how the method may be implemented in a gNB being an example of the radio network node 12.

FIG. 4 illustrates the method executed at gNB m, but it can be extended for any gNB in the communications network. The method switches the state of gNB the among three possible states:
Active: When a gNB has data activity with some UE. The device is heating.
Inactive: When a gNB has no data activity with any UE. The device is cooling.
Sleep: When a gNB is switched off. The device is cooling.

Let [symbol] be the set of gNBs that can be active to transmit at slot j, an

$${n}_{m}^{budget}$$

be the slot budget available at slot j for gNB m to transmit n^{SSB} consecutive slots conveying SSBs in the next SSB window T^{SSB}, assuming no transmissions until then, defined as:

$${n}_{m}^{budget} = max ( {K}^{cool} {n}_{m}^{slot} - f ( j , {T}^{SSB} ) , 0 ) + {n}^{SSB} ,$$

where f(x,y)=y−(x mod y) stands for the complementary modulus operation, and K^{cool}>1 denotes the number of slots needed to cool down to the temperature prior to a single slot transmission. Action 401.

Check is TRP is active, see action 402. For a gNB m not to change to sleep state, its slot counter

$${n}_{m}^{slot}$$

must not violate at least one out of the two following constraints or conditions, wherein C1 is an example of the first condition and C2 is an example of the second condition:

$$C 1 : {n}_{m}^{slot}$$

cannot exceed threshold

$${n}_{m}^{max} ,$$

i.e.,

$${n}_{m}^{slot} < {n}^{max} ;$$

otherwise gNB m starts suffering overheating issues and must be switched off, then staying in sleep mode during a back-off period

$${n}_{m}^{off} = {K}^{cool} slots .$$

### Action 403.

C2: As gNBs need to always be able to transmit SSBs,

$${n}_{m}^{budget}$$

cannot exceed threshold n^{max} at slot j, i.e.,

$${n}_{m}^{budget} < {n}^{max} ;$$

otherwise, gNB m will suffer overheating issues at the end of T^{SSB}, unless it is switched off, during a back-off period

$${n}_{m}^{off} = {K}^{cool} f ( j , {T}^{SSB} ) slots$$

### Action 404.

For each gNB m, the slot budget is updated, its slot counter

$${n}_{m}^{slot}$$

is monitored, decreasing or increasing its value according to the current gNB state, as well for the back-off period

$${n}_{m}^{off} .$$

### Action 405 and 406.

If

$${n}_{m}^{slot}$$

violates any of the conditions C1 or C2, the gNB m is removed from the set of available gNBs [symbol] , i.e., [symbol] = [symbol] \{m}, and

$${n}_{m}^{off}$$

is set accordingly. During back-off time, the gNB cools its temperature as no slot is transmitted. For completeness, when gNB m leaves sleep mode, it is added back to set [symbol] , i.e., [symbol] = [symbol] ∪{m}.

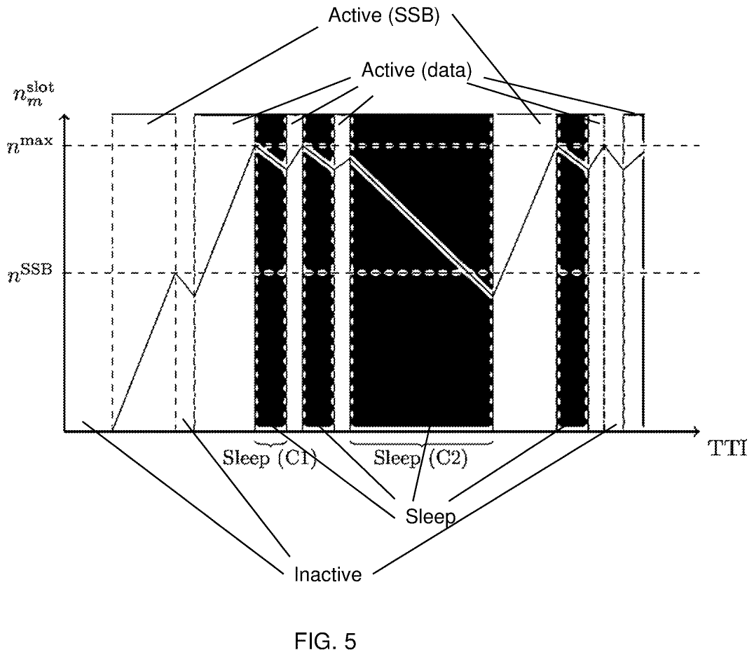

FIG. 5 shows an example of the dynamics of the proposed gNB DTX method showing the slot counter evolving over time for gNB m, being an example of the radio network node 12.

In FIG. 5, different colors are used to illustrate different behaviors of the proposed method along the abscissa. Inactivity, data activity and SSB burst set transmission are all pointed out, respectively. Also sleep mode is indicated. Initially, there is an SSB burst set transmission and the slot counter increases by n^{SSB}. The gNB m stays inactive for a while, then starts data activity, increasing its slot counter until n^{max}, which triggers condition C1, i.e. first condition is fulfilled, and makes the gNB to enter sleep mode. After back-off time

$${n}_{m}^{off} ,$$

it resumes its data activity, but intersperses between data activity and sleep mode due to C1, until C2 is trigged, i.e. the second condition is fulfilled, as the next SSB burst set transmission approaches. The back-off time due to C2 lasts until the beginning of the corresponding SSB burst set. After transmission of that SSB burst set, the gNB can resume its data activity, and the method keeps tracking of the slot counter according to C1 and C2.

The algorithm that implements actions in the flowchart of FIG. 4 represents a linear model, as seen in FIG. 5, that approximates the gNB thermal behavior when heating/cooling. Clearly, all the parameters herein defined, such as n^{max},

$${n}_{m}^{budget}$$

and K^{cool}, can be adapted to fit better the actual gNB thermal behavior. Temperature sensors may also be used to adapt for individual gNB and its environment and surrounding temperature.

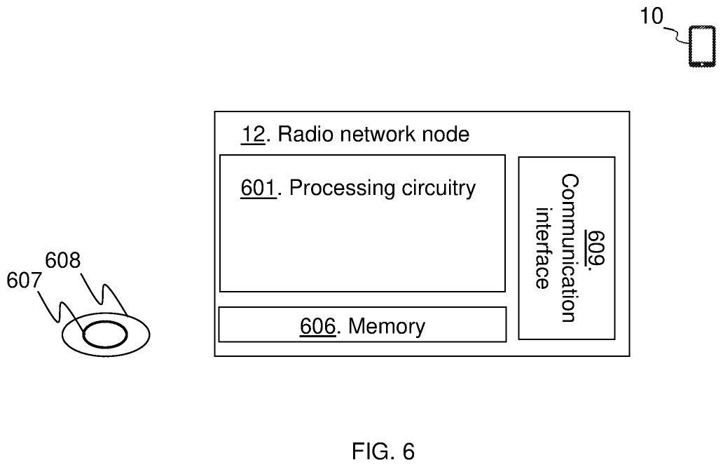

FIG. 6 is a block diagram depicting the radio network node 12 for handling communication in the wireless communication network 1 according to embodiments herein.

The radio network node 12 may comprise processing circuitry 601, e.g. one or more processors, configured to perform the methods herein.

The radio network node 12 and/or the processing circuitry 601 is configured to determine whether or not the first condition related to the first parameter associated with the slot counter of the radio network node, and/or the second condition related to the second parameter associated with the transmission of one or more synchronization signals is fulfilled. The first condition may comprise the first threshold for the first parameter, which first threshold defines the upper limit of the first parameter. The second condition may comprise the second threshold related to the second parameter. The second threshold may be defined by the first parameter and the second parameter.

The radio network node 12 and/or the processing circuitry 601 is configured to, based on whether the first and/or the second condition is fulfilled or not, perform the operation action related to transmission and/or reception of one or more signals.

The operation action may comprise switching an operation mode of the radio network node to a sleep mode or an inactive mode in case the first condition and/or the second condition is not fulfilled. For example, the slot counter is not below the first or the second threshold. The radio network node 12 may be kept in sleep mode or inactive mode based on the pre-set time interval, which pre-set time interval is related to whether it was the first condition or the second condition that was not fulfilled. The operation action may comprise transmitting a synchronization signal or a data transmission in case the first condition and/or the second condition is fulfilled. For example, in case the slot counter is below the first or the second threshold.

The radio network node 12 and/or the processing circuitry 601 may be configured to adjust the first parameter associated with the slot counter based on performing a transmission operation of the radio network node. For example, incrementing the slot counter, whenever a slot transmitted, or decrementing it otherwise.

The radio network node 12 and/or the processing circuitry 601 may be configured to configure the second parameter based on transmission of a block synchronization signals.

The radio network node 12 further comprises a memory 606. The memory comprises one or more units to be used to store data on, such as indications, slot counters, slot estimators, temperature indications, CSI information, requests, configuration, strengths or qualities, grants, indications, requests, commands, timers, applications to perform the methods disclosed herein when being executed, and similar. Thus, the first radio network node 12 may comprise the processing circuitry and the memory, said memory comprising instructions executable by said processing circuitry whereby said radio network node 12 is operative to perform the methods herein. The radio network node 12 comprises a communication interface 609 comprising e.g., one or more antennas.

The methods according to the embodiments described herein for the radio network node 12 are respectively implemented by means of e.g., a computer program product 607 or a computer program, comprising instructions, i.e., software code portions, which, when executed on at least one processor, cause the at least one processor to carry out the actions described herein, as performed by the radio network node 12. The computer program product 607 may be stored on a computer-readable storage medium 608, e.g., a universal serial bus (USB) stick, a disc, or similar. The computer-readable storage medium 608, having stored thereon the computer program product, may comprise the instructions which, when executed on at least one processor, cause the at least one processor to carry out the actions described herein, as performed by the radio network node 12. In some embodiments, the computer-readable storage medium may be a non-transitory or a transitory computer-readable storage medium.

In some embodiments a more general term “radio network node” is used and it can correspond to any type of radio network node or any network node, which communicates with a wireless device and/or with another network node. Examples of network nodes are NodeB, Master eNB, Secondary eNB, a network node belonging to Master cell group (MCG) or Secondary Cell Group (SCG), base station (BS), multi-standard radio (MSR) radio node such as MSR BS, eNodeB, network controller, radio network controller (RNC), base station controller (BSC), relay, donor node controlling relay, base transceiver station (BTS), access point (AP), transmission points, transmission nodes, Remote Radio Unit (RRU), Remote Radio Head (RRH), nodes in distributed antenna system (DAS), core network node e.g. Mobility Switching Centre (MSC), Mobile Management Entity (MME) etc., Operation and Maintenance (O&M), Operation Support System (OSS), Self-Organizing Network (SON), positioning node e.g. Evolved Serving Mobile Location Centre (E-SMLC), Minimizing Drive Test (MDT), etc.

In some embodiments, the non-limiting term wireless device or user equipment (UE) is used and it refers to any type of wireless device communicating with a network node and/or with another UE in a cellular or mobile communication system. Examples of UE are target device, device-to-device (D2D) UE, proximity capable UE (aka ProSe UE), machine type UE or UE capable of machine to machine (M2M) communication, PDA, PAD, Tablet, mobile terminals, smart phone, laptop embedded equipped (LEE), laptop mounted equipment (LME), USB dongles etc.

The embodiments are described for 5G. However the embodiments are applicable to any RAT or multi-RAT systems, where the UE receives and/or transmit signals (e.g. data) e.g. LTE, LTE FDD/TDD, WCDMA/HSPA, GSM/GERAN, Wi Fi, WLAN, CDMA2000 etc.

As will be readily understood by those familiar with communications design, functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communications devices will appreciate the cost, performance, and maintenance trade-offs inherent in these design choices.

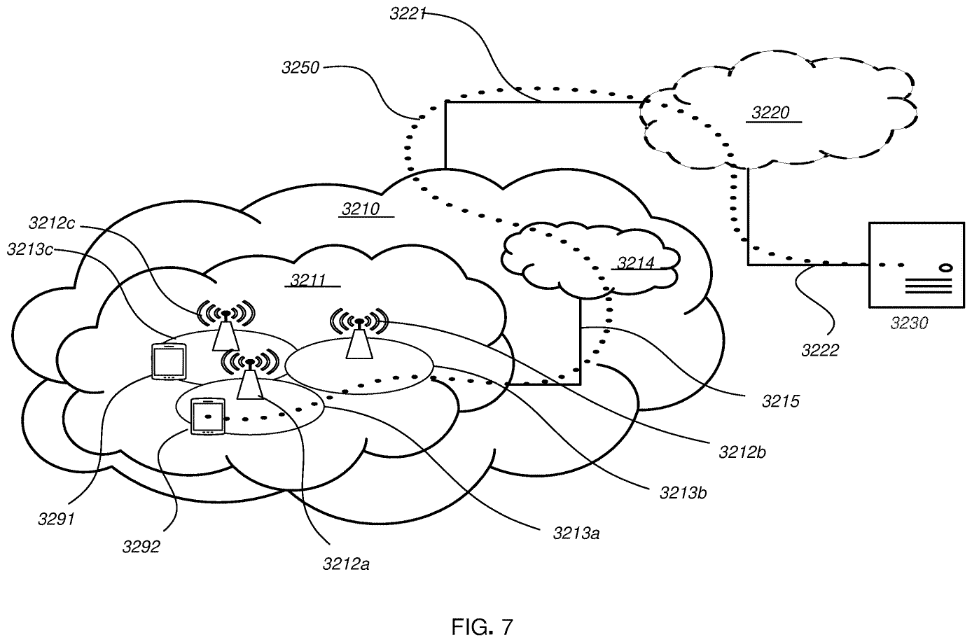

With reference to FIG. 7, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10 and relay UE 13, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 7 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

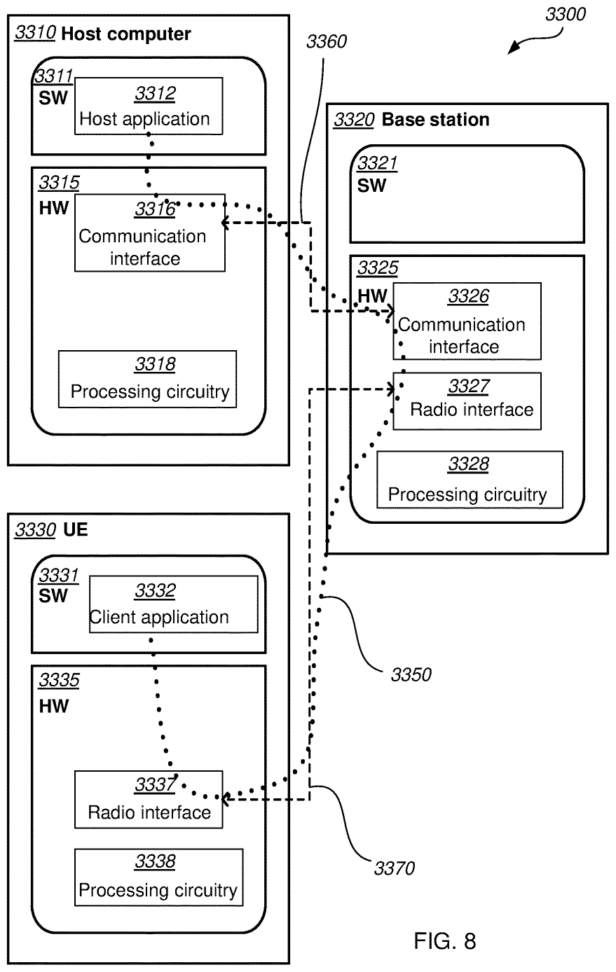

Example implementations, in accordance with an embodiment, of the UE, base station and host computer discussed in the preceding paragraphs will now be described with reference to FIG. 8. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 8) served by the base station 3320. The communication interface 3326 may be configured to facilitate a connection 3360 to the host computer 3310. The connection 3360 may be direct or it may pass through a core network (not shown in FIG. 8) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 8 may be identical to the host computer 3230, one of the base stations 3212a, 3212b, 3212c and one of the UEs 3291, 3292 of FIG. 7, respectively. This is to say, the inner workings of these entities may be as shown in FIG. 8 and independently, the surrounding network topology may be that of FIG. 7.

In FIG. 8, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since radio network node will not overheat and is enabled to transmit synchronization signal(s) and thereby provide benefits such as reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

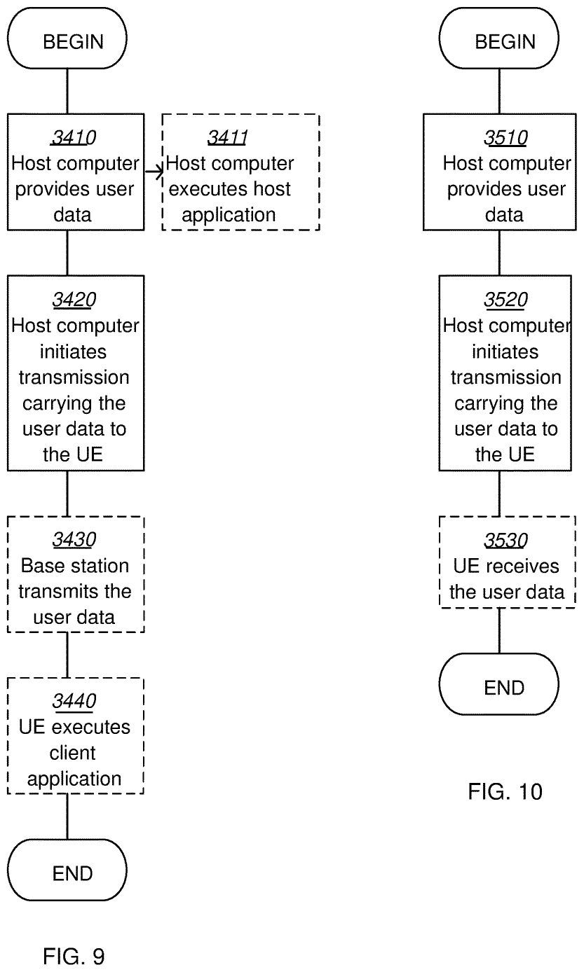

FIG. 9 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 9 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 10 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 10 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

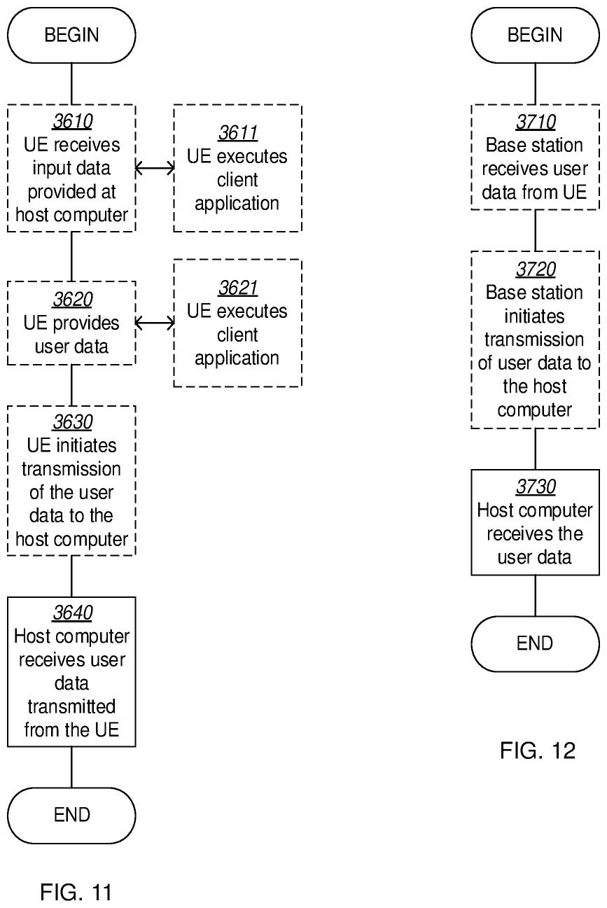

FIG. 11 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 11 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 12 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 12 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

### Abbreviations

5G Fifth generation
6G Sixth generation
AD Analog-to-digital
C1 Condition 1
C2 Condition 2
DA Digital-to-analog
DRX Discontinuous reception
DTX Discontinuous transmission
gNB Next generation NodeB
MIMO Multiple-input multiple-output
mmW Millimeter wave
NR New radio
SSB Synchronization signal block
UE User equipment

1. A method performed by a radio network node for handling communication in a wireless communication network, the method comprising:
determining whether or not a first condition related to a first parameter associated with a slot counter of the radio network node, and/or a second condition related to a second parameter associated with a transmission of one or more synchronization signals is fulfilled; and
based on whether the first and/or the second condition is fulfilled or not, performing an operation action related to transmission and/or reception of one or more signals.

2. The method according to claim 1, wherein the first condition comprises a first threshold for the first parameter, which first threshold defines an upper limit of the first parameter.

3. The method according to claim 1, wherein the second condition comprises a second threshold related to the second parameter.

4. The method according to claim 1, wherein the second threshold is defined by the first parameter and the second parameter.

5. The method according to claim 1, wherein the operation action comprises switching an operation mode of the radio network node to a sleep mode or an inactive mode in case the first condition and/or the second condition is not fulfilled.

6. The method according to claim 5, wherein the radio network node is kept in sleep mode or inactive mode based on a pre-set time interval, which pre-set time interval is related to whether it was the first condition or the second condition that was not fulfilled.

7. The method according to claim 1, wherein the operation action comprises transmitting a synchronization signal or a data transmission in case the first condition and/or the second condition is fulfilled.

8. The method according to claim 1, further comprising:
adjusting the first parameter associated with the slot counter based on performing a transmission operation of the radio network node.

9. The method according to claim 1, further comprising:
configuring the second parameter based on transmission of a block synchronization signals.

10. A computer program product comprising instructions, which, when executed on at least one processor, cause the at least one processor to:
determine whether or not a first condition related to a first parameter associated with a slot counter of the radio network node, and/or a second condition related to a second parameter associated with a transmission of one or more synchronization signals is fulfilled; and
based on whether the first and/or the second condition is fulfilled or not, perform an operation action related to transmission and/or reception of one or more signals.

11. (canceled)

12. A radio network node for handling communication in a wireless communication network, wherein the radio network node is configured to;
determine whether or not a first condition related to a first parameter associated with a slot counter of the radio network node, and/or a second condition related to a second parameter associated with a transmission of one or more synchronization signals is fulfilled; and
based on whether the first and/or the second condition is fulfilled or not, perform an operation action related to transmission and/or reception of one or more signals.

13. The radio network node according to claim 12, wherein the first condition comprises a first threshold for the first parameter, which first threshold defines an upper limit of the first parameter.

14. The radio network node according to claim 12, wherein the second condition comprises a second threshold related to the second parameter.

15. The radio network node according to claim 12, wherein the second threshold is defined by the first parameter and the second parameter.

16. The radio network node according to claim 2, wherein the operation action comprises switching an operation mode of the radio network node to a sleep mode or an inactive mode in case the first condition and/or the second condition is not fulfilled.

17. The radio network node according to claim 16, wherein the radio network node is kept in sleep mode or inactive mode based on a pre-set time interval, which pre-set time interval is related to whether it was the first condition or the second condition that was not fulfilled.

18. The radio network node according to claim 12, wherein the operation action comprises transmitting a synchronization signal or a data transmission in case the first condition and/or the second condition is fulfilled.

19. The radio network node according to claim 2, wherein the radio network node is further configured to;
adjust the first parameter associated with the slot counter based on performing a transmission operation of the radio network node.

20. The radio network node according to claim 12, wherein the radio network node is further configured to:
configure the second parameter based on transmission of a block synchronization signals.
